(19) United States
(12) Patent Application Publication
(10) Pub. No.: US 2009/0302600 A1
(43) Pub. Date: Dec. 10, 2009

(54) METAL COUPLING WITH LOCKED POSITION

(76) Inventors: Philippe Blivet, Rennes (FR); Philippe Poder, Guichen (FR)

Correspondence Address: Muncy, Geissler, Olds & Lowe, PLLC, P.O. BOX 1364, FAIRFAX, VA, 22038-1364, US

(21) Appl. No.: 12/374,272

(22) PCT Filed: Jun. 28, 2007
(86) PCT No.: PCT/FR07/01089

§ 371 Date: Jan. 16, 2009

(30) Foreign Application Priority Data
Jul. 17, 2006 (FR) 06 06465

(51) Int. Cl. F16L 37/098

(52) U.S. Cl. 285/307

(57) ABSTRACT

A coupling comprising a body and a sleeve mounted coaxially on the body, the body defining a housing opening out in a face of the body to enable an end portion of the duct to be inserted therein, wherein the sleeve has an end projecting from said face of the body and provided with a catch step for catching the duct, wherein the sleeve is deformable radially and elastically from an endpiece-retaining state towards an endpiece-passing state, wherein the sleeve is mounted on the body to slide between first and second positions that are in successive relative to an insertion direction for inserting the duct into the housing, and wherein the body and the sleeve include complementary portions in relief that co-operate together when the sleeve is in its first position to hold the sleeve in its retaining state, and that are disengaged from each another when the sleeve is in its second position.

### BACKGROUND OF THE INVENTION

1. Field of the Invention

The present invention relates to a coupling for a duct, suitable for use in particular in fluid transport circuits, and more particularly in motor vehicle fuel circuits, for the purpose of connecting a fluid emitter member to a fluid receiver member such as pipes, a pump, a tank, a valve, an injector, an actuator,.

2. Brief Summary of the Related Art

Known couplings are made either of metal or of plastics material. Nevertheless, metal couplings are now tending to replace plastics couplings in the fuel circuits of motor vehicles because their mechanical strength reduces the risk of gasoline leaking in the event of an accident. Nevertheless, designing such metal couplings is more difficult than designing plastics couplings, since metal does not make it possible at a competitive fabrication cost to provide the same freedom in producing shapes as can be provided with plastics material.

Instantaneous connection metal couplings are known for endpieces that include an end portion extending beyond a collar, the coupling comprising a body defining a housing arranged to receive the end portion of the endpiece in leaktight manner and provided internally with means for catching the collar, said means comprising inclined fingers that are lifted when the collar goes past them on the endpiece being inserted into the housing, and that return resiliently behind the collar after it has gone past them so as to oppose withdrawal of the endpiece by jamming against the collar. Disconnecting the endpiece requires a tool to be inserted between the peripheral surface of the endpiece and the wall of the housing for the purpose of lifting the fingers so as to enable the collar to go past. Unfortunately, with certain circuits, it is not possible to provide sufficient space for passing the tool, thus preventing such couplings being used.

There also exist metal couplings with a pin for an endpiece that includes an end portion extending beyond a collar, the coupling having a body defining a housing that is arranged to receive the end portion of the endpiece in leaktight manner and being provided with a lateral opening leading into the housing so as to make it possible, once the endpiece has been inserted in the housing, to place a pin behind the collar of the endpiece. It is necessary to provide means for retaining the pin on the body in order to prevent the pin being disengaged therefrom or even lost.

Furthermore, and in general, metal couplings present the drawback of being heavier than plastics couplings, thereby constraining coupling manufacturers to limit the quantity of metal used without sacrificing the robustness of the connection.

### SUMMARY OF THE INVENTION

An object of the invention is to provide a coupling that is practical in use and relatively light in weight, providing a connection that is reliable and robust and that can be made when needed out of metal of relatively moderate cost.

To this end, the invention provides a coupling for a duct, the coupling comprising an inner element and an outer element, namely a body and a sleeve mounted coaxially on the body, the body defining a housing opening out in a face of the body to enable an end portion of the duct to be inserted therein. The sleeve has an end projecting from said face of the body and provided with a catch step for catching the duct, and the sleeve is deformable radially and elastically from an endpiece-retaining state to an endpiece-passing state. The sleeve is mounted on the body to slide between first and second successive positions relative to an insertion direction for inserting the duct into the housing, the body and the sleeve including complementary portions in relief that co-operate together when the sleeve is in its first position to hold the sleeve in its retaining state, and that are disengaged from each another when the sleeve is in its second position.

Thus, the end portion of the duct can be inserted into the housing while the sleeve is in its second position in which it is free to deform towards its passing state. When an extraction force is exerted on the duct, the sleeve under resilient urging towards its retaining state is entrained towards its first position by the duct. Co-operation between the complementary portions in relief then reinforces the catching of the duct by the step, by opposing any deformation of the sleeve towards its passing state.

Preferably the coupling comprises, in addition to the complementary portions in relief for holding the sleeve in its retaining state, complementary portions in relief that co-operate together when the sleeve is in a third position situated beyond the second position, to hold the sleeve in its passing state and that are disengaged from each other when the sleeve is in its second position, the complementary portions in relief for holding the sleeve in the passing state are of shapes such that the third position of the sleeve is an unstable position.

Inserting the duct into the housing is thus made easier when the sleeve is in its third position. After the duct has been inserted, the sleeve returns spontaneously to its second position because the third position is not stable, thereby ensuring that the sleeve is not left forgotten in its passing state after the duct has been inserted.

In a particular embodiment, the complementary portions in relief comprise an inclined tongue secured to one of the elements of the coupling and received in an opening formed in the other element of the coupling and possessing an edge for co-operating with the tongue, and the tongue preferably possesses a first face facing a first edge of the opening to form the complementary portions in relief for holding the sleeve in its retaining state, and a second face facing a second edge of the opening to form the complementary portions in relief for holding the sleeve in the passing state.

This embodiment is particularly simple.

Advantageously, the sleeve is split by a longitudinal slot.

The longitudinal slot makes it easier to deform the sleeve and makes it possible to use a material that is relatively rigid.

It is then preferable for the coupling to include a drive part for driving the sleeve, the drive part being mounted on the sleeve in register with the longitudinal slot according to a first characteristic and/or the sleeve drive part co-operating with edges of the longitudinal slot to move said edges apart from each other when the drive part is pulled towards the third position of the sleeve according to a second characteristic.

The first characteristic of the drive part serves to prevent the operator being pinched when handling the sleeve. The second characteristic makes it easier to deform the sleeve while an operator is moving the sleeve towards its third position.

Other characteristics and advantages of the invention appear on reading the following description of a particular, non-limiting embodiment of the invention.

### BRIEF DESCRIPTION OF THE DRAWINGS

The present invention will become more fully understood from the detailed description given hereinbelow and the accompanying drawings, which are given by way of illustration only and thus are not limitative of the present invention, and in which:

FIG. 1 is a diagrammatic longitudinal section view of a coupling in accordance with the invention;

FIG. 2 is a view of a coupling analogous to that of FIG. 1 while a duct is being inserted;

FIG. 3 is a view of a coupling analogous to that of FIG. 1 after the duct has been inserted;

FIG. 4 is a view of a coupling analogous to that of FIG. 1 when a traction force is exerted on the duct;

FIG. 5 is a perspective view of the coupling; and

FIG. 6 is an exploded perspective view of the sleeve of the coupling.

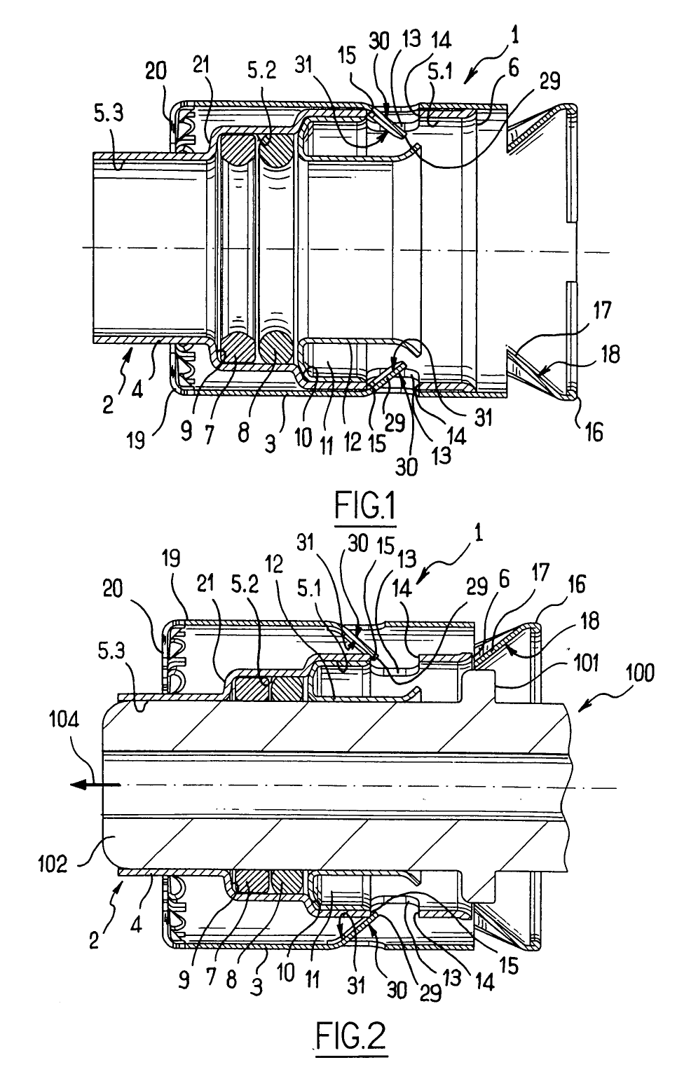

### DETAILED DESCRIPTION OF THE PREFERRED EMBODIMENTS

With reference to the figures, the coupling in accordance with the invention is for connecting a member to a duct of a fluid transport circuit. The member and the duct may be a fluid emitter or a fluid receiver. By way of example the member is a pipe, a pump, a tank, a valve, an actuator, an injector, . . . . The duct given overall reference 100 in the figures may be formed integrally with some other member of the fluid transport circuit or it may be connected thereto by means that are themselves known. The duct 100 includes an outer collar 101 and an end portion 102 extending beyond the collar 101.

The coupling of the invention, given overall reference 1, comprises a body 2 surrounded by a sleeve 3 respectively forming an inside element and an outside element, both of stainless steel. Other metals could naturally be used, as indeed could thermoplastics or composite materials.

The body 2, e.g. made by stamping or thermoforming, is axially subdivided into a section for coupling to the duct 100 and a section (not visible in the figures) for connection to the member with which the duct 100 is to be connected. The section for connection to the member may be identical to the section for connection to the duct 100 or it may be integral with said member, or it may be provided with instantaneous connection means (e.g. a deformable washer, a radial latch, a clamp, . . . ) or non-instantaneous connection means (in particular by means of a pin), means for anchoring it in a channel of the member (e.g. portions in relief forming a Christmas-tree shape or beads), . . . .

The body 2 comprises a wall 4 that is tubular and stepped, defining beside the section for connection to the duct 100 a housing 5 having an inlet segment 5.1 opening out into an end face 6 of the wall 4 and connected to an intermediate segment 5.2, itself connected to a terminal segment 5.3 for communicating with the member to which the duct 100 is to be connected.

The terminal segment 5.3 has a diameter substantially equal to the outside diameter of the end segment 102. The intermediate segment 5.2 has a diameter greater than that of the terminal segment 5.3 and receives sealing rings 7, 8 of inside diameter smaller than the outside diameter of the end portion 102. The intermediate segment 5.2 is connected via a shoulder 9 to the terminal segment 5.3. The inlet segment 5.1 has a diameter greater than the diameter of the collar 101 and greater than the diameter of the intermediate segment 5.2, to which it is connected by a shoulder 10, and it receives a guide bushing 11 made of sheet metal rolled into a torus shape and having a J-shaped section, the riser of the J-shape generating in revolution the inner wall 12 of the guide busing 11, of diameter substantially equal to the outside diameter of the end portion 102. The inner wall 12 flares towards the end face 6 to facilitate inserting the end portion 102. The guide bushing 11 bears against the shoulder 10 so as to retain the sealing rings 7, 8.

Between the guide bushing 11 and the end face 6, the wall 4 presents two openings 13 situated facing each other. Each opening 13 has two edges 14, 15 extending parallel to transverse planes of the body 2, respectively beside the end face 6 and beside the guide bushing 11.

The sleeve 3, e.g. made by rolling up sheet metal, possesses an end 16 projecting axially from the end face 6 and provided with catch steps 17 projecting radially inwards. The catch steps 17 are constituted by plunged bosses formed in the sleeve 3 and each presenting facing the end 6 a sloping face 18. Remote from its end 16, the sleeve 3 possesses an end 19 provided with abutment steps 20 for co-operating with an outside shoulder 21 of the body 2.

Tongues 29 are cut out in the sleeve 3.

Each tongue 29 extends in an axial direction of the sleeve 3 and comprises, at its end beside the end 19 a portion that is connected to the sleeve 3, and at its end that is beside the end 16, an end portion that projects towards the inside of the sleeve 3 such that each tongue 29 is inclined and passes into one of the openings 13. Each tongue thus has a face 30 facing towards the edge 14, and a face 31 facing towards the edge 15.

The sleeve 3 is split by a longitudinal slot and is elastically deformable between a rest state, referred to as a retaining state, in which the catch steps 17 define a through section of diameter smaller than the diameter of the collar 101, and a deformed state, referred to as a passing state, in which the catch steps 17 define a through section of diameter greater than the diameter of the collar 101.

A drive part 22 is mounted on the sleeve 3 in such a manner as to extend over the slot 23 so as to mask it. The drive part 22 has two studs 24, 25 that are received in notches 26, 27 formed in each edge 28 of the slot 23 respectively beside the end 19 and beside the end 16. The studs 24, 25 serve to retain the drive part 22 on the sleeve 3. The notches 26 are rectangular in shape, while the notches 27 present a shape corresponding substantially to half of an ace of spades, the edge of each notch 27 having a segment that converges progressively towards the edge 28 going towards the notches 26. The notches 26 are longer than the stud 24. Thus, when the drive part 22 is moved towards the end 19 of the sleeve 3, the stud 25 is inserted between the converging segments of the notches 27 and tends to deform the sleeve 3 into its passing state.

The sleeve 3 is mounted on the body 2 so as to move between a first position and a third position that are situated on either side of a second position and that are in succession relative to the direction 104 for inserting the duct 100 into the housing 5.

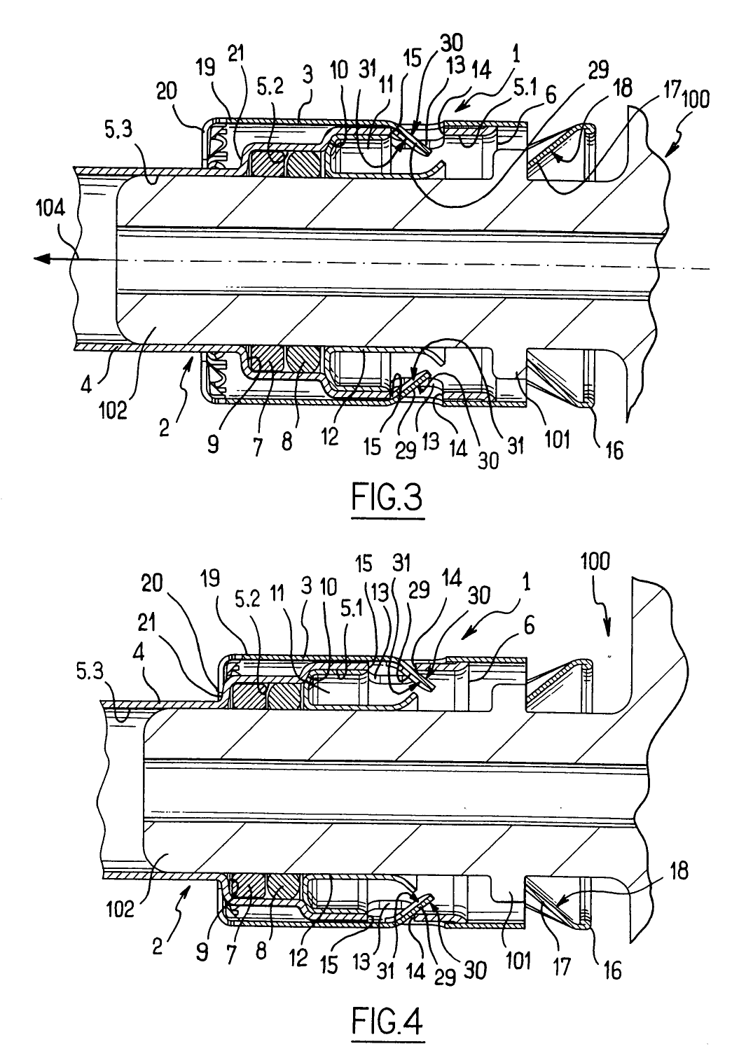

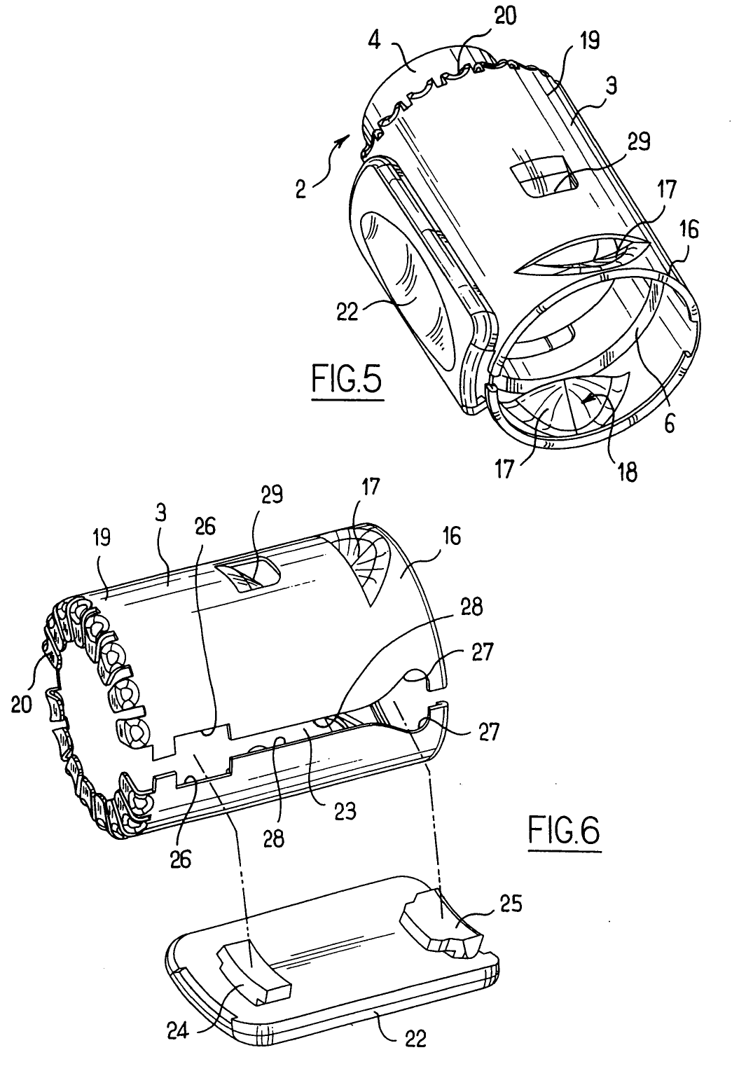

The second position (as shown in FIGS. 1 and 3) is a neutral position in which the sleeve 3 is free to deform between its retaining state and its passing state. The tongues 29 are disengaged from the edges 14, 15.

The duct is generally connected while the sleeve is in this position. The collar 101 encounters the sloping faces 18 of the catch steps 17 and slides over them, thereby deforming the sleeve 3 by camming it towards its passing state (see FIG. 3). In addition, under the force of inserting the duct 100, the sleeve 3 tends to move back towards its third position such that the face 31 of each tongue 29 lies over the edge 15 of the corresponding opening 13 and also serves to deform the sleeve 3 by camming, the tongues 29 and the edges 15 forming complementary portions in relief. Deforming the sleeve 3 into its passing state enables the collar 101 to go past the catch steps 17. Insertion of the end portion 102 of the duct 100 into the housing 5 is interrupted when the collar 101 comes into abutment against the inner wall 12 of the guide bushing 11. Once the collar 101 has gone past the catch steps 17, the sleeve 3 returns elastically to its retaining state, the catch steps 17 then opposing extraction of the duct 100 by bearing against the rear surface of the collar 101. It should be observed that the inner wall 12 extends in axial projection from the free ends of the tongues 29 when the sleeve 3 is in its second position, such that an engagement force exerted on the duct 100 cannot move the duct 100 in the housing 5 and cannot give rise to any interference between the duct 100 and the tongues 29.

When the circuit in which the duct 100 and the coupling 1 are incorporated is put under pressure, or when an extraction force is exerted on the duct 100, the duct 100 moves backwards relative to the body 2 and entrains the sleeve 3 towards its first, or locked position (see FIG. 4). The free end of each tongue then passes under the edge 14 of the corresponding opening 13, and the face 30 of each tongue 29 comes into contact with said edge 14 to form a cam for holding the sleeve 3 in its retaining state and to reinforce the engagement of the collar of the duct 100. The tongues 29 and the edges 14 form complementary portions in relief. The abutment steps 20 bear against the shoulder 21 and oppose extraction of the sleeve 3.

In order to disconnect the duct 100 from the coupling 1, the operator moves the sleeve 3 into its third, or disconnection position by using the drive part 22. The drive part 22 is thus moved towards the end 19 of the sleeve 3, the stud 25 is inserted between the converging segments of the notches 27 and tends to move the edges 28 of the slot 23 apart, thereby deforming the sleeve 3 into its passing state. The stud 24 comes into abutment against the notch 26 and moves the sleeve 3 towards its third position. The face 31 of each tongue 29 then slides over the edge 15 of the corresponding opening 13 and also forms a cam for deforming the sleeve 3. The sleeve 3 in its passing state enables the duct 100 to be extracted from the housing 5. It should be observed that the resilience of the sleeve 3 tends to return it into its retaining state and thus towards its second position. The third position is thus an unstable position, the inclination of the tongues 29 encouraging this return towards the second position.

Naturally, the invention is not limited to the embodiment described and covers any variant coming within the ambit of the invention as defined by the claims.

In particular, the catch steps 17 may be formed by curved tabs. The number of steps may be different from the number in the embodiment described, and the same applies to the number of tongues and of openings.

The ability to disconnect is optional.

The drive part may be omitted or arranged to constitute no more than means for masking the slot.

The invention can be used with ducts that do not have a collar or that have some other type of portion in relief.

In addition, provision can be made to have two tongues that are axially in succession, one for holding in the retaining position and one for deformation, or to have tongues of other shapes, such as sawtooth shapes.

It is also possible to make a coupling of the invention by functionally inverting the coupling described.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A coupling for a duct, the coupling comprising an inner element and an outer element, namely a body and a sleeve mounted coaxially on the body, the body defining a housing opening out in a face of the body to enable an end portion of the duct to be inserted therein, wherein the sleeve has an end projecting from said face of the body and provided with a catch step for catching the duct, wherein the sleeve is deformable radially and elastically from a duct-retaining state to a duct-passing state, wherein the sleeve is mounted on the body to slide between first and second successive positions relative to an insertion direction for inserting the duct into the housing, and wherein the body and the sleeve include complementary portions in relief that co-operate together when the sleeve is in its first position to hold the sleeve in its retaining state, and that are disengaged from each another when the sleeve is in its second position.

2. A coupling according to claim 1, including, in addition to the complementary portions in relief for holding the sleeve in its retaining state, complementary portions in relief that co-operate together when the sleeve is in a third position situated beyond the second position, to hold the sleeve in its passing state and that are disengaged from each other when the sleeve is in its second position.

3. A coupling according to claim 2, wherein the complementary portions in relief for holding the sleeve in the passing state are of shapes such that the third position of the sleeve is an unstable position.

4. A coupling according to claim 1, wherein the complementary portions in relief comprise an inclined tongue secured to one of the elements of the coupling and received in an opening formed in the other element of the coupling, and possessing an edge for co-operating with the tongue.

5. A coupling according to claim 2, wherein the complementary portions in relief comprise an inclined tongue secured to one of the elements of the coupling and received in an opening formed in the other element of the coupling, and possessing an edge for co-operating with the tongue, and wherein the tongue possesses a first face facing a first edge of the opening to form the complementary portions in relief for holding the sleeve in its retaining state, and a second face facing a second edge of the opening to form the complementary portions in relief for holding the sleeve in the passing state.

6. A coupling according to claim 1, wherein the sleeve is split by a longitudinal slot.

7. A coupling according to claim 6, including a drive piece for driving the sleeve and mounted on the sleeve in register with the longitudinal slot.

8. A coupling according to claim 6, wherein the sleeve is split by a longitudinal slot, and the coupling includes a drive piece for the sleeve that co-operates with edges of the longitudinal slot to move these edges apart from each other when the drive part is pulled towards the third position of the sleeve.

9. A coupling according to claim 1, including a guide bushing for guiding the end portion of the duct, the guide bushing being mounted in the housing and being formed by a metal sheet rolled into a torus of J-shaped section.

10. A coupling according to claim 9, wherein the catch step is formed by a plunged boss formed in the sleeve.

11. A coupling according to claim 9, wherein the sleeve possesses an end remote from the catch step, which end is provided with at least one curved tab to form a portion in relief for anchoring the sleeve of the body.

12. A coupling according to claim 1, wherein the catch step has a front surface sloping in such a manner as to encourage the sleeve to deform towards its passing state during insertion of the duct.

13. A coupling according to claim 1, wherein the end portion of the duct extends beyond a portion in relief, and the catch step is arranged to retain said portion in relief.
